(19) United States
(12) Patent Application Publication
(10) Pub. No.: US 2020/0097951 A1
(43) Pub. Date: Mar. 26, 2020

(54) CRYPTOCURRENCY SYSTEM USING BODY ACTIVITY DATA

(71) Applicant: Microsoft Technology Licensing, LLC, Redmond, WA (US)

(72) Inventors: Dustin ABRAMSON, Renton, WA (US); Derrick FU, Seattle, WA (US); Joseph Edwin JOHNSON, JR., Seattle, WA (US)

(73) Assignee: Microsoft Technology Licensing, LLC, Redmond, WA (US)

(21) Appl. No.: 16/138,518

(22) Filed: Sep. 21, 2018

(51) Int. Cl. G06Q 20/36; G06F 3/01; H04L 9/06; H04L 9/08

(52) U.S. Cl. CPC G06Q 20/3672; H04L 9/0866; H04L 9/0637; G06F 3/011

(57) ABSTRACT

Human body activity associated with a task provided to a user may be used in a mining process of a cryptocurrency system. A server may provide a task to a device of a user which is communicatively coupled to the server. A sensor communicatively coupled to or comprised in the device of the user may sense body activity of the user. Body activity data may be generated based on the sensed body activity of the user. The cryptocurrency system communicatively coupled to the device of the user may verify if the body activity data satisfies one or more conditions set by the cryptocurrency system, and award cryptocurrency to the user whose body activity data is verified.

### BACKGROUND

A virtual currency (also known as a digital currency) is a medium of exchange implemented through the Internet generally, not tied to a specific government-backed “flat” (printed) currency such as the U.S. dollar or the Euro, and typically designed to allow instantaneous transactions and borderless transfer of ownership. One example of virtual currency is cryptocurrency, wherein cryptography is used to secure transactions and to control the creation of new units.

Several cryptocurrencies exist. Among these, the most well known is a blockchain-based cryptocurrency. Most blockchain-based cryptocurrency is decentralized in the sense that it has no central point of control. However, blockchain-based cryptocurrency can also be implemented in a centralized system having a central point of control over the cryptocurrency. Bitcoin is one of the examples of blockchain-based cryptocurrency. It is described in a 2008 article by Satoshi Nakamoto, named “Bitcoin: A peer-to-Peer Electronic Cash System,” the entire content of which is incorporated herein by reference.

A blockchain is a data structure that stores a list of transactions and can be thought of as a distributed electronic ledger that records transactions between source identifier(s) and destination identifier(s). The transactions are bundled into blocks and every block (except for the first block) refers back to or is linked to a prior block in the blockchain. Computer resources (or nodes, etc.) maintain the blockchain and cryptographically validate each new block and the transactions contained in the corresponding block. This validation process includes computationally solving a difficult problem that is also easy to verify and is sometimes called a “proof-of-work”. This process is referred to as “mining”. The mining may be a random process with low probability so that a lot of trial and error is required to solve a computationally difficult problem. Accordingly, the mining may require enormous amounts of computational energy.

It is with respect to these and other general considerations that the following embodiments have been described. Also, although relatively specific problems have been discussed, it should be understood that the embodiments should not be limited to solving the specific problems identified in the background.

### SUMMARY

Some exemplary embodiments of the present disclosure may use human body activity associated with a task provided to a user as a solution to “mining” challenges in cryptocurrency systems. For example, a brain wave or body heat emitted from the user when the user performs the task provided by an information or service provider, such as viewing advertisement or using certain internet services, can be used in the mining process. Instead of massive computation work required by some conventional cryptocurrency systems, data generated based on the body activity of the user can be a proof-of-work, and therefore, a user can solve the computationally difficult problem unconsciously. Accordingly, certain exemplary embodiments of the present disclosure may reduce computational energy for the mining process as well as make the mining process faster.

Systems, methods, and hardware aspects of computer readable storage media are provided herein for a cryptocurrency system using human body activity data. According to various embodiments of the present disclosure, a server may provide a task to a device of a user which is communicatively coupled to the server. A sensor communicatively coupled to or comprised in the device of the user may sense body activity of the user. Body activity data may be generated based on the sensed body activity of the user. A cryptocurrency system communicatively coupled to the device of the user may verify whether or not the body activity data satisfies one or more conditions set by the cryptocurrency system, and award cryptocurrency to the user whose body activity data is verified.

Examples are implemented as a computer process, a computing system, or as an article of manufacture such as a device, computer program product, or computer readable medium. According to one aspect, the computer program product is a computer storage medium readable by a computer system and encoding a computer program comprising instructions for executing a computer process.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 illustrates an example environment in which some exemplary embodiments of the present disclosure may be practiced;

FIG. 2 shows a system diagram of a decentralized cryptocurrency system according to an exemplary embodiment of the present disclosure;

FIG. 3 shows a flow diagram of a computer-implemented method according to an exemplary embodiment of the present disclosure;

FIG. 4 shows a flow diagram of an operation for generating body activity data according to an exemplary embodiment of the present disclosure;

FIG. 5 shows a flow diagram of an operation for verifying body activity data according to an exemplary embodiment of the present disclosure;

FIG. 6 illustrates a blockchain and two exemplary blocks of the blockchain according to an exemplary embodiment of the present disclosure;

FIG. 7 shows a flow diagram of a computer-implemented method using a vector or embedding according to another exemplary embodiment of the present disclosure; and

FIG. 8 illustrates an exemplary block diagram of a computer or processing system in which processes involved in the system, method, and computer program product described herein may be implemented.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part hereof, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

The term “cryptocurrency” may mean a digital currency in which encryption techniques are used to regulate the generation of units of currency and verify the transfer of funds. Many cryptocurrencies include the use of a blockchain to provide security and prevent fraud as double spending. Some embodiments of the present disclosure may be used in alternate cryptocurrency mechanisms other than a blockchain. The system, method, and computer program products described herein may be applied to both centralized and decentralized cryptocurrency networks or databases.

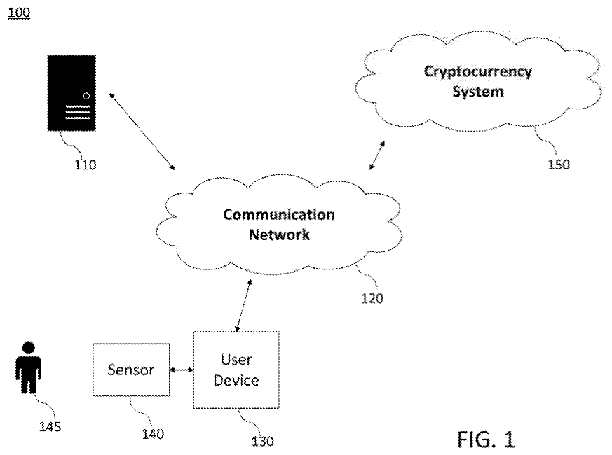

FIG. 1 illustrates an example environment 100 in which some exemplary embodiments of the present disclosure may be practiced. The example environment 100 includes, but is not limited to, at least one of task server 110, communication network 120, user device 130, sensor 140, and cryptocurrency system 150.

Task server 110 may provide one or more tasks to user device 130 over communication network 120. For example, task server 110 may be at least one of a web server delivering or serving up web pages, an application server handling application operations between users and applications or databases, a cloud server, a database server, a file server, a service server, a game server implementing games or services for a game, and a media server delivering media such as streaming video or audio. The tasks provided by task server 110 will be discussed in more detail below.

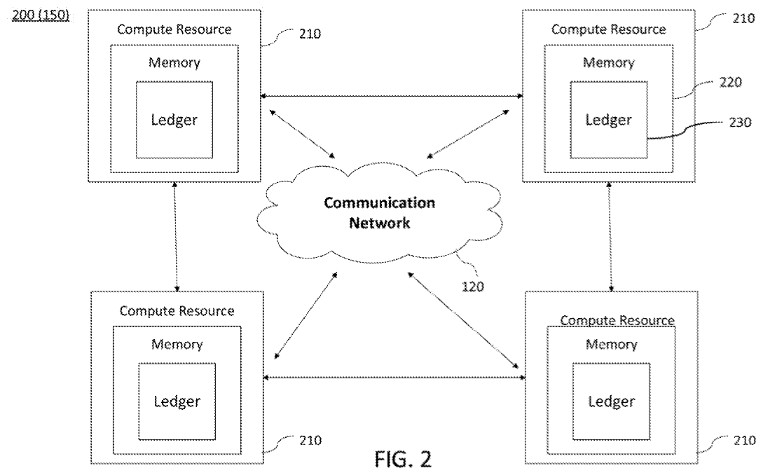

Alternatively, cryptocurrency system 150 may provide one or more tasks to user device 130. For example, in a decentralized cryptocurrency network, the tasks may be proposed to user device 130 by miners (e.g. compute resources or nodes 210 of FIG. 2). In another example, in a centralized cryptocurrency system, a cryptocurrency server may send the tasks to user device 130.

Communication network 120 may include any wired or wireless connection, the internet, or any other form of communication. Although one network 120 is identified in FIG. 1, communication network 120 may include any number of different communication networks between any of the server, devices, resource and system shown in FIGS. 1 and 2 and/or other servers, devices, resources and systems described herein. Communication network 120 may enable communication between various computing resources or devices, servers, and systems. Various implementations of communication network 120 may employ different types of networks, for example, but not limited to, computer networks, telecommunications networks (e.g., cellular), mobile wireless data networks, and any combination of these and/or other networks.

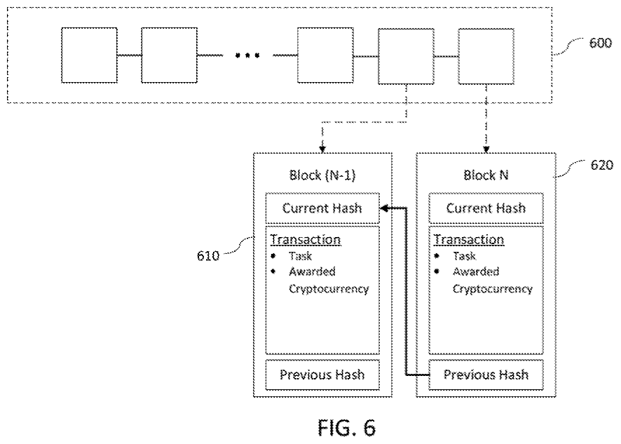

User device 130 may include any device capable of processing and storing data/information and communicating over communication network 120. For example, user device 130 may include personal computers, servers, cell phones, tablets, laptops, smart devices (e.g. smart watches or smart televisions). An exemplary embodiment of user device 130 is illustrated in FIG. 6.

Sensor 140 may be configured to sense the body activity of user 145. As illustrated in FIG. 1, sensor 140 may be a separate component from user device 130 and be operably and/or communicatively connected to user device 130. Alternatively, sensor 140 may be included and integrated in user device 130. For example, user device 130 may be a wearable device having sensor 140 therein. The sensor 140 may transmit information/data to user device 130. Sensor 140 may include, for example, but not limited to, functional magnetic resonance imaging (fMRI) scanners or sensors, electroencephalography (EEG) sensors, near infrared spectroscopy (NIRS) sensors, heart rate monitors, thermal sensors, optical sensors, radio frequency (RF) sensors, ultrasonic sensors, cameras, or any other sensor or scanner that can measure or sense body activity or scan human body. For instance, the fMRI may measure body activity by detecting changes associated with blood flow. The fMRI may use a magnetic field and radio waves to create detailed images of the body (e.g. blood flow in the brain to detect areas of activity). The material (http://news.berkely.edu/2011/09/22/brain-movies/), the entire content of which is incorporated herein by reference, shows one example of how the fMRI can measure brain activity associated with visual information and generate image data.

Cryptocurrency system 150 may include one or more processors for processing commands and one or more memories storing information in one or more cryptocurrency data structures. In some embodiments, cryptocurrency system 150 may be a centralized cryptocurrency system or network, for example, but not limited to, a server which may be privately run by a third party entity or the same entity that is running the task server 110. In other embodiments, cryptocurrency system 150 may be a publically accessible network system (e.g., a distributed decentralized computing system).

For example, cryptocurrency system 150 may be a decentralized network 200, such as a decentralized blockchain network, including one or more compute resources 210, as shown, for example, in FIG. 2. In the embodiment of FIG. 2, there may be no central authority controlling cryptocurrency network 200. The data stored on blockchain network 200, i.e., the public ledger, may not be stored at a central location in its entirety. Blockchain network 200 may include a plurality of processors for processing commands and a plurality of memories storing information in one or more blockchain data structures. Blockchain network 200 may maintain one or more blockchains of continuously growing lists of data blocks, where each data block refers to previous blocks on its list. The requirement for each block to refer to all previous blocks in the blockchain, yields a chain of blocks that is hardened against tampering and revision, such that the information stored in the blockchain is immutable.

Compute resources 210 may include any device, computer, system or otherwise that has joined blockchain network 200 and forms a node in blockchain network 200. Compute resources 210 may include, for example, but not limited to, personal computers, servers, cell phones, tablets, laptops, smart devices (e.g. smart watches or smart televisions), or any other device capable of storing information and communicating over communication network 120. In some embodiments, compute resources 210 may be unaffiliated with or unknown to each other where, for example, compute resources 210 remain anonymous. Each compute resource 210 may include memory 220 that stores a copy of at least a portion of public ledger 230 of blockchain network 200. Compute resources 210 may also execute one or more programs to perform various functions associated with maintaining blockchain network 200 including, for example, updating public ledger 230, generating new blocks, or any other similar function.

For illustration purposes, FIG. 1 illustrates user device 130 as not included in blockchain network 200. However, user device 130 may be part of blockchain network 200 and be implemented as one of the compute resources 210 in FIG. 2.

Public ledger 230 may store any transactions performed over blockchain network 200 including but not limited to, for example, any transaction related to and occurring on blockchain network 200. Because each compute resource 210 stores a copy of at least a portion of the public ledger 230 of blockchain network 200, public ledger 230 may be independently verified for accuracy at any time by comparing the stored copies of multiple compute resources 210.

Communication between compute resources 210 may occur via communication network 120. Communication network 120 of FIG. 2 may be the same network as, or be a different network from, communication 120 of FIG. 1. In some embodiments, each compute resource 210 may communicate directly with each other compute resource 210. In some embodiments, some compute resources 210 may not be able to communicate directly with each other. For example, they are not connected to the same communications network 120. In this case, communications related to blockchain network 200 between the compute resources 210 may occur by using one or more of the remaining compute resources 210 as an intermediary. In some embodiments, one or more of compute resources 210 may not maintain a continuous connection to blockchain network 200 at all times. For example, a compute resource 210 may only be connected to blockchain network 200 during a certain period of time each day or may only be connected to blockchain network 200 intermittently throughout the day. Due to the decentralized nature of blockchain network 200, such an intermittent connection by one or more compute resources 210 does not affect the overall operation of blockchain network 200 since copies of public ledger 230 are stored on multiple compute resources 210. Once the disconnected compute resource 210 reconnects to blockchain network 200, the disconnected compute resource 210 may receive updated copies of the public ledger 210 from one or more of the compute resources 210 that have been connected to blockchain network 200.

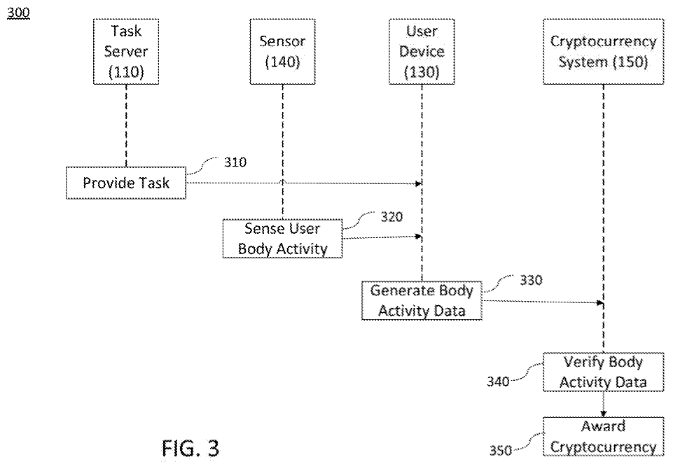

FIG. 3 shows a flow diagram of a computer-implemented method according to an exemplary embodiment of the present disclosure.

Method 300 begins at operation 310 illustrated in FIG. 3, where task server 110 provides one or more tasks to device 130 of user 145 over communication network 120. The tasks include, for example, but not limited to, watching or listening information (e.g. advertisement) for a certain time, using services (e.g. search engine, chat bot, e-mail, social media/networking service and any internet or web service), uploading or sending information/data to a website, a server or a network (e.g. content sharing website, and cloud network or server), or any other information or service which may produce effects on users. In the blockchain, the task(s) may be included as a transaction in the public ledger 230.

Furthermore, the task(s) provided by task server 110 can include solving a test for distinguishing human from machine input so that humans but not computers are able to pass it, such as, Computer Automated Program to Tell Computers and Humans Apart (CAPTCHA) and reCAPTCHA which is a CAPTCHA-like system designed to establish that a computer user is human. The task may require user 145 to solve a verification challenge, for example, but not limited to, an image based challenge including instructions prompting user 145 to solve the challenge through interaction with one or more images.

At operation 320, when or after user 145 performs the task(s) provided by task server 110, sensor 140 may sense the body activity of user 145 that is a body response related to the task provided by task server 110, and then transmit the sensed body activity of user 145 to user device 130. The body activity may include, for example, but not limited to, radiation emitted from human body, brain activities, body fluid flow (e.g. blood flow), organ activity or movement, body movement, and any other activities that can be sensed and represented by images, waves, signals, texts, numbers, degrees, or any other form of information or data. Examples of body radiation emitted from human body may include radiant heat of the body, pulse rate, or brain wave. Brain waves may comprise, for example, but not limited to, (i) gamma waves, involved in learning or memory tasks, (ii) beta waves, involved in logical thinking and/or conscious thought, (iii) alpha waves, which may be related to subconscious thoughts, (iv) theta waves, which may be related to thoughts involving deep and raw emotions, (v) delta waves, which may be involved in sleep or deep relaxation, or (vi) electroencephalogram (EEG), which may be measurement used to evaluate the electrical activity in the brain, such as deep concentration. Examples of the body movement may include eye movement, facial movement or any other muscular movements. Furthermore, brain activity can be sensed using the fMRI. The fMRI measures brain activity by detecting changes associated with blood flow. This technique relies on the fact that cerebral blood flow and neuronal activation are coupled. When an area of the brain is in use, blood flow to that region also increases.

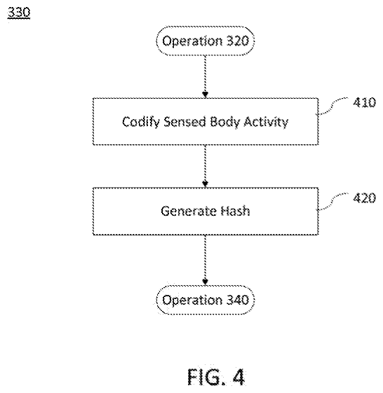

At operation 330, user device 130 generates body activity data based on the body activity sensed by sensor 140. Operation 330 may be part of a mining process which is a process for solving a computationally difficult problem. One exemplary embodiment of operation 330 is shown in FIG. 4. As shown in FIG. 4, operation 330 may comprise operations 410 and 420.

At operation 410, the body activity sensed by sensor 140 may be codified in symbolic forms, such as letter(s), numeral(s), symbol(s), and a string comprising sequence of characters. In one example, the body activity can be codified by extracting one or more values from the sensed body activity, such as minimum and/or maximum amplitude(s) or frequency(ies) of a body activity signal (e.g. brain waves). In another example, user device 130 may window and sample the sensed body activity over time and calculate the average of the sampled values. In still another example, user device 130 may generate raw data of the body activity. In still another example, user device 130 may filter a raw signal of the body activity using one or more filters to apply the filtered body activity signal to an audio hash function or algorithm at operation 420. Alternatively, any statistic value(s) associated with human body activity can be codified from the body activity sensed by sensor 140.

At operation 420, the codified body activity may be converted into an encrypted output by using an encryption algorithm, such as a hash algorithm or function. For example, hash functions include functions that map an initial input data set of an output data set. Generally, the hash function may be any function that can be used to map data of arbitrary size to data of fixed size. The hash function allows one to easily verify that some input data maps to a given hash value, but if the input data is unknown, it is deliberately difficult to reconstruct it (or any equivalent alternatives) by knowing the stored hash value. The hash algorithm or function may be included in the mining software or program of the cryptocurrency system or database.

For example, operation 420 may use audio hash function, where the histogram of frequencies of the codified body activity are summed up, or bit manipulation, such as XOR function of each histogram bucket with the next or a modulus of a prime number, is performed on the codified body activity.

In some embodiments, an analog hash function where the body activities themselves are hashes can be used. For example, waves or signals sensed by sensor 140, for example, but not limited to, alpha, beta, delta or gamma waves from the EEG sensor, may be transformed to a histogram using a transforming algorithm or formula, such as Fast Fourier Transform (FFT) or any other algorithm or formula that can convolve, add or multiply waves or signals to produce a histogram. The hash may be the histogram itself. For example, the hash may be the output of the FFT where each component is a frequency band and the value is counts corresponding to each frequency band. In another example, the desired properties may be that the first two frequency histograms are as close to zero as possible, for instance, provided some statistical guarantee exists that this cannot happen easily.

However, operation 420 is optional. In certain embodiments, user device 130, without encrypting or hashing the codified body activity, may transmit the codified body activity generated at operation 410 to cryptocurrency system 150.

Although FIG. 3 illustrates that operation 330, including operation 410 and 420, is processed by user device 130, at least one of operations 410 and 420 can be processed by another device(s), server, resource or system, such as task server 110, cryptocurrency system 150 or any other server. For example, the user device 130 may generate raw data of the sensed body activity, transmit it to cryptocurrency system 150, task server 110 or any other server, and then cryptocurrency system 150, task server 110 or any other server may codify or hash the raw data of the sensed body activity.

Referring back to FIG. 3, at operation 340, cryptocurrency system 150 verifies if the body activity data of user 145 generated by user device 130 satisfies one or more conditions set by an algorithm of cryptocurrency system 150. The conditions may be set by simulating human body activity across all of body activities that can constitute hashes. Machine learning algorithms may be used to simulate body activities and set the conditions for valid body activities, for example, but not limited to, using generative adversarial networks.

In some embodiments, cryptocurrency system 150 verifies whether the body activity data of user 145 (e.g. the code of the body activity generated at operation 410 or the hash of the body activity generated at operation 420) may represent that the body activity of user 145 is within a target range. The target range may be determined using the amount of cognitive effort that user 145 requires to perform the task provided by task server 110. For example, to verify if the hash of the body activity of user 145, cryptocurrency system 150 may determine, for example, but not limited to, (i) whether the hash of the body activity of user 145 has a specific certain pattern, repeated patterns, a mathematical properties or the number of leading numbers, characters or strings (e.g. leading zeroes) set by cryptocurrency system 150, or (ii) whether the hash of the body activity of user 145 is less than a current target value. Examples of the numerical patterns set by cryptocurrency system 150 may be a pattern that first certain digits of the hash form a prime number, or a pattern that a number that is calculated by applying first certain digits of the hash to a preset formula forms a prime number (For example, a number calculated by adding or subtracting a predetermined number or a number set by cryptocurrency system 150 to the first four digits of the hashing forms a prime number). The repeating number patterns may include a repeating number (e.g. leading zeros, ones in the middle of the hash, twos in the last four digits of the hash, and any repeating numbers included in the hash) and a repeating number sequence (e.g. leading repeating digit pairs, such as “121212”, or triplets “123123”). If the hash of the body activity of user 145 has the desirable pattern(s) or is within the target range, then the proof of work or proof of stake is considered solved, and that hash can be a new block. The target range or value may be changed periodically to maintain a preselected level of difficulty, although it is not required. For example, the target value may be inversely proportional to the difficulty. By varying the difficulty, a roughly constant rate of block generation may be kept.

The target range of valid body activity may be set using statistical data so that normal body activity, activity that can easily happen, or faking body activity cannot be validated. For example, the target range of valid body activity may be selected from a range that human miners cannot fake their own body activity to satisfy the target range to prove and validate the proof-of-work.

Additionally, the verification at operation 340 may include filtering out invalid tasks, malformed data (syntax errors) or data sent from an unauthorized user or generated by a machine learning system. For example, cryptocurrency system 150 may receive, from user device 130, data of the body activity generated before the hash algorithm is applied, rehash that data, and then compare the rehashed data with the hash received from user device 130 to check whether the body activity data is generated based on human, not random computer generated data. Voxel(s) of the image of the fMRI may be an example of the data of the body activity generated before the hash algorithm is applied.

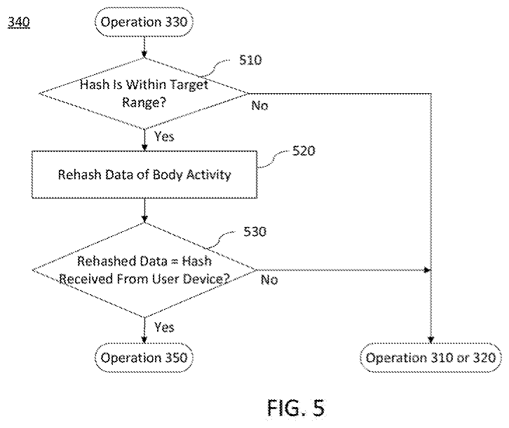

One exemplary embodiment of operation 340 is shown in FIG. 5. At operation 510, cryptocurrency system 150 may check whether the hash of the body activity, received from user device 130, is within the target range set by cryptocurrency system 150, or comprises a desirable pattern set by cryptocurrency system 150. If the hash of the body activity is within the target range or has a desirable pattern set by cryptocurrency system 150, cryptocurrency system 150 rehashes data of the body activity, generated before the hash algorithm is applied and transmitted with the hash of the body activity from user device 130 (Operation 520), and then compare the rehashed data with the hash of the body activity, received from user device 130 (Operation 530). If the rehashed data is identical to the hash of the body activity, received from user device 130, cryptocurrency system 150 proceeds to operation 350. However, if determining in operation 510 that the hash of the body activity data is out of the target range or does not include the desirable pattern set by cryptocurrency system 150 or if determining in operation 530 that the rehashed data does not match the hash of the body activity, operation 310 or 320 may be proceeded.

At operation 350, when the body activity data transmitted from user device 130 satisfies one or more conditions set by cryptocurrency system 150, cryptocurrency system 150 awards cryptocurrency to user 145. For example, cryptocurrency system 150 awards to user 145 an amount of cryptocurrency corresponding to the task accomplished by user 145. Additionally, cryptocurrency system 150 may award cryptocurrency to an owner or operator of task server 110 as a reward for providing services, such as, search engines, chatbots, applications or websites, offering users access for free to paid contents (e.g. video and audio streaming or electric books), or sharing information or data with users.

For example, in the blockchain cryptocurrency system, at operation 340, at least one of compute resources 210 of FIG. 2 verifies if the hash of the body activity data of user 145 is valid. At operation 350, when the hash of the body activity data of user 145 is validated at operation 340, the compute resource 210 of FIG. 2 can add a new block to the blockchain. The new block may contain the number of cryptocurrency units assigned to the user's address. The new blockchain with the additional added block is broadcasted around the cryptocurrency network 150. The compute resource 210, which performed operations 340 and 350, may be also rewarded with transaction fees and/or cryptocurrency.

FIG. 5 depicts a blockchain 500 and two exemplary blocks 510, 520 of blockchain 500 according to exemplary embodiments of the present disclosure. Typically a “blockchain” is understood as being a data structure comprising a series of blocks, where each block includes data corresponding to one or more transactions, hashed together with linking data, such as the hash of an immediately preceding block. In the embodiment of the present disclosure, the transaction may be the task performed by user 145. The chain can then be used to create a ledger, which is typically an append-only database. Once data is entered into a block of the chain, the entry is essentially irrefutable, since any tampering with the data would be reflected in the chained hash calculations and is thus easily detected.

The blockchain 500 may represent the publicly distributable transactions ledger, such as ledger 230 of FIG. 2, and may include a plurality of blocks. Each block, such as block 510 and block 520 may include data regarding recent transactions. For example, the task performed by user 145 and the number of cryptocurrency units awarded to user 145, and/or contents linking data that links one block 520 to a previous block 510, and proof-of-work data, for example, the validated hash of the body activity, that ensures that the state of the blockchain 500 is valid and is endorsed/verified by a majority of the record keeping system. Exemplary embodiments of block 520 of blockchain 500 may include a current hash, a previous hash of previous block 510, transaction. The previous hash is a hash from the immediately preceding block, which ensures that each block is immutably tied to previous block. The hash of previous block 510 may be included in block 520, thereby linking block 520 to previous block 510.

Transaction information cannot be modified without at least one of compute resources 210 noticing, thus, the blockchain 500 can be trusted to verify transactions occurring on blockchain 500.

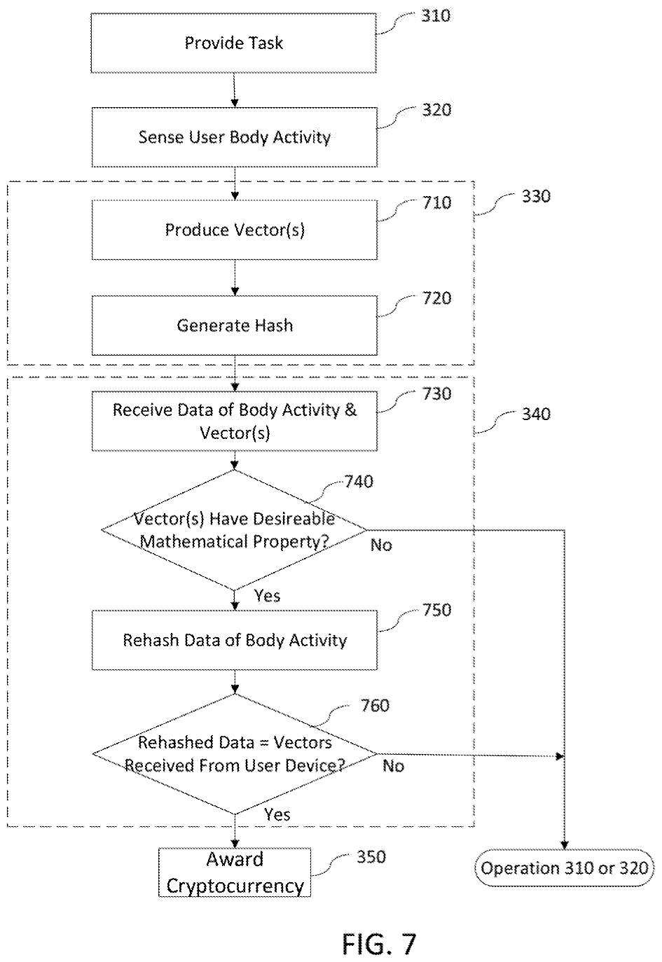

In some embodiments, vectors or embeddings may be used for body activity data. FIG. 7 shows a flow diagram of an exemplary embodiment of a computer-implemented method using vectors (or embedding). As described in detail above with respect to FIG. 3, task server 110 or cryptocurrency system/network 150, such as a central cryptocurrency server or compute resource (or node) 210, may perform operation 310 where one or more tasks are proposed to user device 130 over communication network 120, and sensor 140 may perform operation 320 where sensor 140 senses or measures the body activity of user 145. Sensor 140 (or user device 130) may generate data of the body activity in the form of images, waves, signals, numbers, characters, strings or any other form that can represent the body activity.

At operation 710, user device 130 produces one or more vectors (or embeddings), such as an array of floating point numbers, from the data of the body activity generated by sensor 140 (or user device 130). An algorithm stored in user device 130, or any device, server, system or network communicatively connected to user device 130 over communication network 120, may transform the data of the body activity generated by sensor 140 (or user device 130) into one or more vectors. For example, the brain image generated by the fMRI scanner may be fed into a computer vision machine learning algorithm, for example, but limited to, a convolution neural network, and the machine learning algorithm may generate one or more vectors from one or more voxels of the brain image. In some embodiments, one single vector may be generated at operation 710. In other embodiments, a series of vectors may be produced by sampling over time when user 145 is performing the task(s). The data of the body activity (e.g. voxels of a brain image) and/or the vectors (or embeddings) may generate a “proof of work” and be transmitted to cryptocurrency system/network 150.

In addition, the vectors may optionally include one or more vectors related to the task(s), for example, but not limited to, search terms that user 145 used or identifier(s) of advertisement that user 145 viewed.

At operation 720, the vector(s) generated at operation 710 may be converted into an encrypted output by using an encryption algorithm, such as a hashing algorithm or function, as explained above with respect to operation 420 of FIG. 4. For example, the vector(s) can be hashed as bytes with the hashing algorithm, such as Secure Hash Algorithm (SHA)-1, SHA-256, SHA-384, SHA-512, and Message Digest (MD)-5.

However, operation 720 is optional. In some embodiments, user device 130 can transmit the vector(s) of the body activity produced at operation 710 to cryptocurrency system 150 without encrypting or hashing them.

At operation 730, cryptocurrency system 150 receives, from user device 130, the data of the body activity of user 145 (e.g. voxels of a brain image) and/or the vector(s) (or the hash) of the body activity of user 145.

At operation 740, cryptocurrency system 150 checks if the vector(s) received from user device 130 have one or more mathematical properties set by cryptocurrency system/network 150. For example, cryptocurrency system 150 may determine whether the vector(s) of the body activity have similarity (or relationship) with a legitimate vector (or a baseline vector) set by an algorithm of cryptocurrency system 150. The similarity may be measured or calculated using, for example, but not limited to, a cosine similarity, the Euclidean distance, the Manhattan distance, the Minkowski distance, and the Jaccard similarity. The legitimate vector may be set based on the assumption that the vectors of body activities of people who are performing the same task have a certain degree of similarity. Cryptocurrency system 150, such as a central cryptocurrency server/network or compute resource (or node) 210 of FIG. 2, can decide the legitimate vector and similarity. For example, miners like compute resources (or nodes) 210 of FIG. 2 can share their proof of work including, for example, but not limited to, vectors of body activities, with cryptocurrency network 150, and decide the legitimate vector and similarity by calculating the average of the proof of work (e.g. a centroid or weighted average of the vectors and a standard deviation).

If the vector(s) received from user device 130 have the mathematical property(ies) set by cryptocurrency system/network 150, cryptocurrency system/network 150 rehashes the data of the body activity, transmitted from user device 130 (Operation 750), and then compares the rehashed output with the vectors (or the hash) received from user device 130 (Operation 760). For example, computer resource (or node) 210 of FIG. 2 may rehash the fMRI voxels, transmitted from user device 130, to a vector, and then compare the rehashed vector with the vector received from user device 130 to check whether the body activity data is generated based on human, not random computer generated data. If determining in operation 740 that the vector(s) received user device 130 do not satisfy the mathematical property(ies) set by cryptocurrency system/network 150 or if determining in operation 760 that the rehashed output does not match the vector(s) (or the hash) received from user device 130, operation 310 or 320 may be proceeded.

If the rehashed output is identical to the vector(s) (or the hash) received from user device 130, cryptocurrency system/network 150 awards cryptocurrency to user 145 as described in detail above with respect to operation 350. For example, in the blockchain cryptocurrency system, a miner, such as one of compute resources (or nodes) 210 of FIG. 2, which performed the validation of the body activity data, may add a new block, which includes the data of the body activity, the vector(s) (or the hash) and/or the number of cryptocurrency units assigned to the user's address, to the blockchain, broadcast a new blockchain with the new block around cryptocurrency network 150, and may be rewarded with transaction fees and/or cryptocurrency.

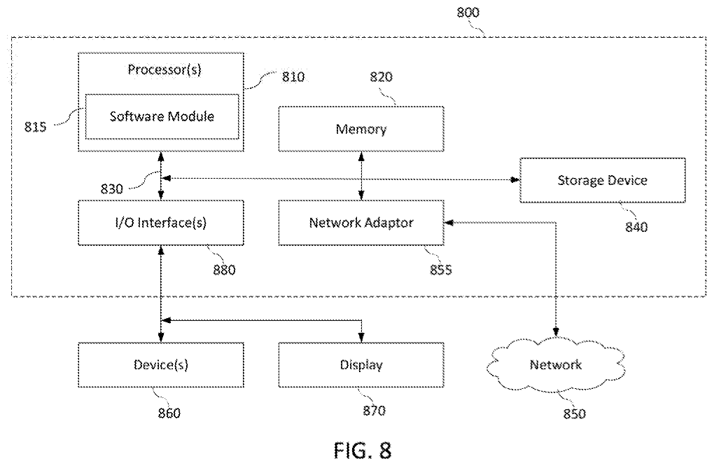

FIG. 8 illustrates a schematic of an example computer or processing system that may implement any of the systems, methods, and computer program products, such as task server 110, user device 130, cryptocurrency system 150 and compute resources 210, described herein in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 8 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system 800 may include, but are not limited to, one or more processors or processing units 810, system memory 820, and bus 830 that couples various system components including system memory 820 to processor 810. Processor 810 may include software module 815 that performs the methods described herein. The module 815 may be programmed into the integrated circuits of processor 810, or loaded from memory 820, storage device 840, or network 850 or combinations thereof.

Bus 830 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus. Enhanced ISA (EISA) bus, Video Electronics Standards Association (VESA) local bus, and Peripheral Component Interconnects (PCI) bus.

Computer system 800 may include a variety of computer system readable media. Such media may be any available media that is accessible by computer system, and it may include both volatile and non-volatile media, removable and non-removable media.

System memory 820 can include computer system readable media in the form of volatile memory, such as random access memory (RAM) and/or cache memory or others. Computer system 800 may further include other removable/non-removable volatile/non-volatile computer system storage media. By way of example only, storage device 840 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 630 by one or more data media interfaces.

Computer system 800 may also communicate with one or more external devices 860 such as a keyboard, a pointing device, a display 870, etc; one or more devices that enable a user to interact with computer system; and/or any devices (e.g., network card, modem, etc.) that enable computer system to communicate with one or more other computing devices. Such communication can occur via Input/Output (I/O) interfaces 880.

Still yet, computer system 800 can communicate with one or more networks 850 such as a local area network (LAN), a general wide area network (WAN), and/or a public network (e.g., the Internet) via network adapter 855. As depicted, network adapter 855 communicates with the other components of computer system via bus 830. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to some embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A cryptocurrency system, comprising:
one or more processors; and
memory storing executable instructions that, if executed by the one or more processors, configure the cryptocurrency system to:
communicate with a device of a user;
receive body activity data which is generated based on body activity of the user, wherein the body activity is sensed by a sensor communicatively coupled to or comprised in the device of the user;
verify if the body activity data of the user satisfies one or more conditions set by the cryptocurrency system; and
award cryptocurrency to the user whose body activity data is verified.

2. The system of claim 1, wherein the body activity sensed by the sensor comprises at least one of body radiation emitted from the user, body fluid flow, a brain wave, pulse rate or body heat radiation.

3. The system of claim 1, wherein the one or more conditions are set based on an amount of human body activity associated with a task which is provided to the device of the user.

4. The system of claim 1, wherein the one or more conditions comprise a condition that the body activity data represents that the user performs a task provided to the device of the user.

5. The system of claim 1, wherein the body activity data is generated using a hash algorithm converting human body activity into an encryption output, and the generated body activity data comprises a hash of the sensed body activity of the user.

6. The system of claim 1, wherein the body activity data comprises one or more vectors produced from the body activity sensed by the sensor.

7. The system of claim 5, wherein the one or more conditions include a condition that the hash of the body activity includes repeated patterns or a mathematical property set by the cryptocurrency system.

8. The system of claim 1, wherein the cryptocurrency system awards the cryptocurrency to the user by generating a block for the awarded cryptocurrency and adding the block to a blockchain stored in the cryptocurrency system.

9. The system of claim 8, wherein the block comprises data comprising:
a task provided to the device of the user;
information on the awarded cryptocurrency;
a hash associated with the body activity; and
a hash of a previous block.

10. The system of claim 3, wherein the task provided to the device of the user comprises a test for verifying if the user of the device is human or not.

11. The system of claim 5, wherein the cryptocurrency system is configured to:
receive, from the device of the user, data of the body activity generated before the hash algorithm is applied and the hash of the body activity;
rehash the data of the body activity; and
compare the rehashed data with the hash of the body activity received from the device of the user to verify the body activity data.

12. A computer-implemented method, comprising:
receiving, by a device of a user coupled to a network, a task over the network;
sensing, by a sensor communicatively coupled to or comprised in the device of the user, body activity of the user;
generating body activity data based on the sensed body activity of the user;
verifying, by a cryptocurrency system communicatively coupled to the device of the user, if the body activity data satisfies one or more conditions set by the cryptocurrency system; and
awarding, by the cryptocurrency system, cryptocurrency to the user whose body activity data is verified.

13. The method of claim 12, wherein the body activity sensed by the sensor comprises at least one of body radiation emitted from the user, body fluid flow, a brain wave, pulse rate or body heat radiation.

14. The method of claim 12, wherein the one or more conditions are set by the cryptocurrency system based on an amount of human body activity associated with the task provided to the device of the user.

15. The method of claim 12, wherein the body activity data is generated using a hash algorithm converting human body activity into an encryption output, and the generated body activity data comprises a hash of the sensed body activity of the user.

16. The method of claim 12, wherein the body activity data comprises one or more vectors produced from the body activity sensed by the sensor.

17. The method of claim 15, further comprising:
receiving, by the cryptocurrency system, from the device of the user, data of the body activity generated before the hash algorithm is applied and the hash of the body activity;
rehashing, by the cryptocurrency system, the data of the body activity; and
comparing, by the cryptocurrency system, the rehashed data with the hash of the body activity received from the device of the user to verify the body activity data.

18. A device, comprising:
one or more processors communicatively coupled to a sensor, the sensor configured to sense body activity of a user; and
memory storing executable instructions that, if executed by the one or more processors, configure the device to:
receive a task;
generate body activity data based on the sensed body activity of the user, wherein the sensed body activity is associated with the received task; and
transmit the generated body activity data to a system or network which verifies the body activity data to award cryptocurrency.

19. The system of claim 18, wherein the body activity sensed by the sensor comprises at least one of body radiation emitted from the user, body fluid flow, a brain wave, pulse rate or body heat radiation.

20. The system of claim 18, wherein the body activity data is generated using a hash algorithm converting human body activity into an encryption output.
